(19) United States
(12) Patent Application Publication
(10) Pub. No.: US 2007/0041195 A1
(43) Pub. Date: Feb. 22, 2007

(54) Light emitting assembly

(75) Inventor: An-Si Chen, Taichung (TW)

Correspondence Address: FITZPATRICK CELLA HARPER & SCINTO, 30 ROCKEFELLER PLAZA, NEW YORK, NY, 10112, US

(73) Assignee: EXCEL CELL ELECTRONIC CO., LTD., Taichung (TW)

(21) Appl. No.: 11/204,826

(22) Filed: Aug. 16, 2005

(51) Int. Cl. F21V 29/00

(52) U.S. Cl. 362/294

(57) ABSTRACT

A light emitting assembly includes at least one light emitting device having a thermally conductive diode seat and a light emitting diode mounted on the diode seat, and a thermally conductive heat-dissipating device having a seat body that has an upper surface on which the diode seat is mounted. The seat body is provided with a plurality of fins that project therefrom and that are spaced apart from each other.

### BACKGROUND OF THE INVENTION

1. Field of the Invention

This invention relates to a light emitting assembly, more particularly to a light emitting assembly including a thermally conductive heat-dissipating device provided with a plurality of fins, and at least one light emitting device mounted on the thermally conductive heat-dissipating device.

2. Description of the Related Art

Lighting devices that include a light emitting diode, such as automotive lighting devices and indoor lighting devices, are known in the art. However, when light is emitted from the light emitting diode, heat will be simultaneously generated by the light emitting diode, and the generated heat will increase with an increase in the intensity of the emitted light. The heat generated has to be sufficiently dissipated. Otherwise, it will accumulate in the light emitting diode and result in an increase in the temperature of the light emitting diode and those of components in the vicinity of the light emitting diode. The light emitting diode and the nearby components are easily damaged due to the elevated temperature.

Therefore, there is a need in the art to provide a light emitting assembly that includes a highly efficient heat-dissipating device.

### SUMMARY OF THE INVENTION

Therefore, the object of the present invention is to provide a light emitting assembly that can overcome the aforesaid drawback of the prior art.

According to this invention, a light emitting assembly includes at least one light emitting device including a thermally conductive diode seat and a light emitting diode mounted on the diode seat, and a thermally conductive heat-dissipating device including a seat body that has an upper surface. The diode seat is mounted on the upper surface of the seat body. The seat body is provided with a plurality of fins that project therefrom and that are spaced apart from each other.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of the first preferred embodiment of a light emitting assembly according to this invention;

FIG. 2 is a schematic cross-sectional view of the first preferred embodiment, illustrating connection between a circuit board and a light emitting device;

FIG. 3 is a perspective view of the second preferred embodiment of the light emitting assembly according to this invention; and

FIG. 4 is a perspective view of the third preferred embodiment of the light emitting assembly according to this invention.

### DETAILED DESCRIPTION OF THE PREFERRED EMBODIMENTS

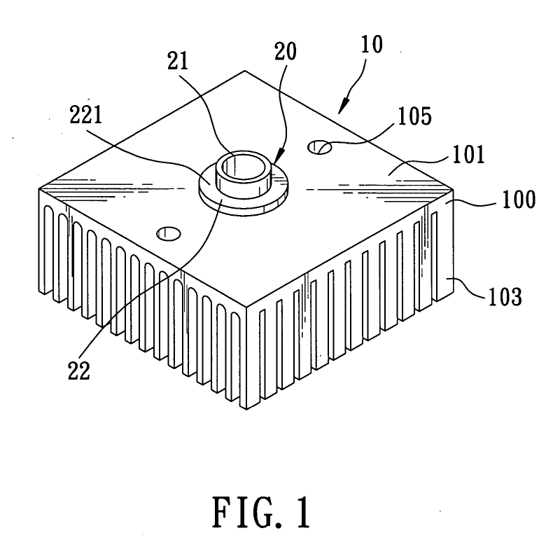

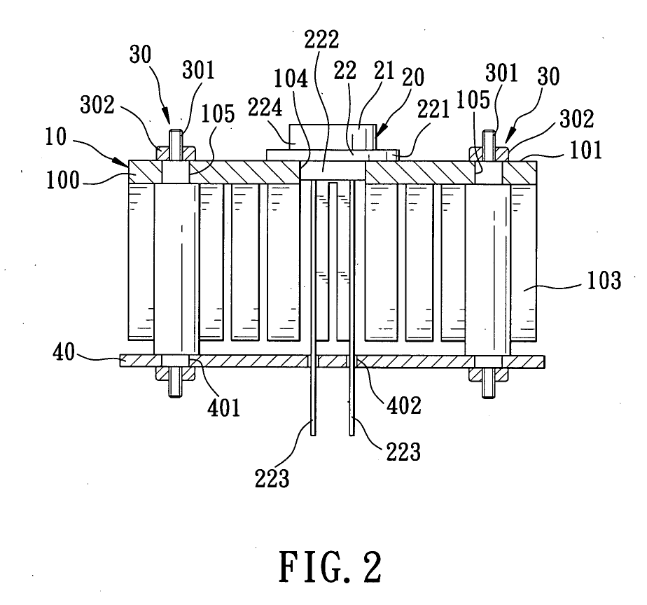

Referring to FIGS. 1 and 2, the first preferred embodiment of a light emitting assembly according to the present invention is shown to include a light emitting device 20 and a thermally conductive heat-dissipating device 10. The light emitting device 20 includes a thermally conductive diode seat 22 and a light emitting diode 21 mounted on the diode seat 22. The thermally conductive heat-dissipating device 10 includes a seat body 100 that has an upper surface 101 on which the diode seat 22 is mounted, and that is provided with a plurality of fins 103 projecting therefrom and spaced apart from each other.

Preferably, the seat body 100 of the heat-dissipating device 10 is formed with a recess 104 indented inwardly from the upper surface 101 of the seat body 100. The diode seat 22 has a cylindrical body 222 that is fitted into the recess 104, and an annular flange 221 that is enlarged in cross-section from the cylindrical body 222 and that contacts the upper surface 101 of the seat body 100 at a periphery of the recess 104.

The diode seat 22 further has an annular wall 224 that extends upwardly, and that is reduced in cross-section from the annular flange 221. The light emitting diode 21 is received in the annular wall 224, and has a pair of conductive terminals 223 extending downwardly through the annular flange 221 and the cylindrical body 222.

Referring to FIG. 2, the light emitting assembly may further include a circuit board 40, and a plurality of fasteners 30. The circuit board 40 is disposed below and is spaced apart from the seat body 100, and the fins 103 extend between the seat body 100 and the circuit board 40. The circuit board 40 has a plurality of first through-holes 401 and a plurality of second through-holes 402. Each of the fasteners 30 extends through a respective fastening hole 105 in the seat body 100 and a respective first through hole 401 in the circuit board 40, so as to secure the circuit board 40 to the seat body 100. In addition, each of the conductive terminals 223, which extend downwardly from the light emitting diode 21, extends through a respective one of the second through-holes 402 so as to couple electrically the light emitting diode 21 to the circuit board 40.

Preferably, each of the fasteners 30 includes a screw rod 301 extending through the respective fastening hole 105 and the respective first through-hole 401, and a pair of screw nuts 302 that engage threadedly and respectively two opposite ends of the screw rod 301.

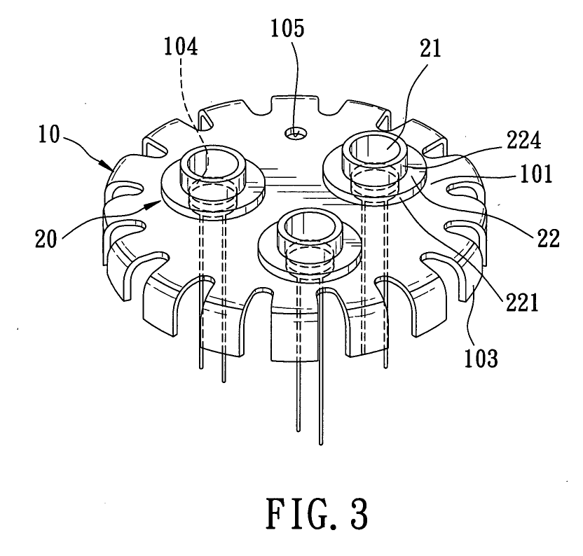

FIG. 3 illustrates the second preferred embodiment of the light emitting assembly according to this invention. In this preferred embodiment, the seat body 100 has a peripheral edge. The fins 103 are distributed along and extend downwardly from the peripheral edge of the seat body 100.

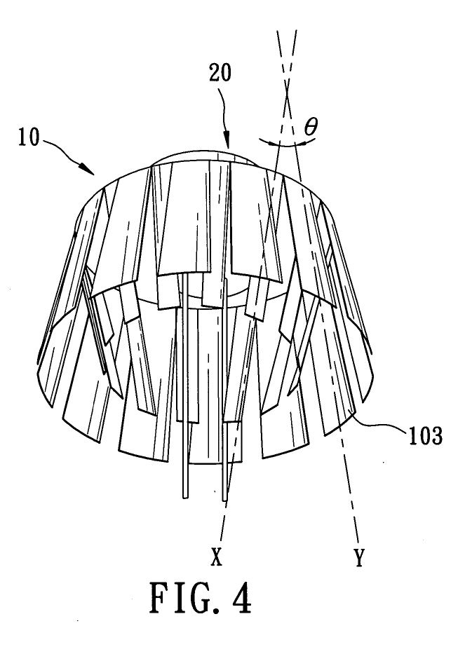

FIG. 4 illustrates the third preferred embodiment of the light emitting assembly according to this invention. In this preferred embodiment, two adjacent ones of the fins 103 extend downwardly from the seat body 100 in a first direction (X) and a second direction (Y), respectively. The first direction (X) and the second direction (Y) form an acute angle θ therebetween.

According to the present invention, the heat generated by the light emitting diode 21 can be efficiently dissipated by the thermally conductive heat-dissipating device 10 by virtue of the fins 103 of a specific design. Therefore, heat damage to the light emitting diode 20 and the nearby components can be avoided.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A light emitting assembly comprising:
at least one light emitting device including a thermally conductive diode seat and a light emitting diode mounted on said diode seat; and
a thermally conductive heat-dissipating device including a seat body that has an upper surface;
wherein said diode seat is mounted on said upper surface of said seat body; and
wherein said seat body is provided with a plurality of fins that project therefrom and that are spaced apart from each other.

2. The light emitting assembly of claim 1, wherein said seat body of said heat-dissipating device is formed with a recess indented inwardly from said upper surface of said seat body, said diode seat having a cylindrical body that is fitted into said recess, and an annular flange that is enlarged in cross-section from said cylindrical body and that contacts said upper surface of said seat body at a periphery of said recess.

3. The light emitting assembly of claim 2, wherein said diode seat further has an annular wall that extends upwardly and that is reduced in cross-section from said annular flange, said light emitting diode being received in said annular wall and having a pair of conductive terminals extending downwardly through said annular flange and said cylindrical body.

4. The light emitting assembly of claim 1, wherein said seat body has a peripheral edge, said fins being distributed along and extending downwardly from said peripheral edge of said seat body.

5. The light emitting assembly of claim 4, wherein two adjacent ones of said fins extend downwardly from said seat body in a first direction and a second direction, respectively, the first direction and the second direction forming an acute angle therebetween.

6. The light emitting assembly of claim 1, further comprising a circuit board that is disposed below said seat body and that is spaced apart from said seat body, and a plurality of fasteners extending through said seat body and said circuit board for securing said circuit board to said seat body, said fins extending between said seat body and said circuit board, said light emitting diode being electrically coupled to said circuit board.
